(19) United States
(12) Patent Application Publication
(10) Pub. No.: US 2012/0111368 A1
(43) Pub. Date: May 10, 2012

(54) PROTECTIVE CAP FOR A CONNECTOR

(75) Inventors: Ismael Rahimy, Friedberg (DE); Torsten Brandenburger, Reichelsheim (DE)

(73) Assignee: Fresenius Kabi Deutschland GmbH, Bad Homburg (DE)

(21) Appl. No.: 13/276,348

(22) Filed: Oct. 19, 2011

Related U.S. Application Data
(60) Provisional application No. 61/394,777, filed on Oct. 20, 2010.

(30) Foreign Application Priority Data
Oct. 20, 2010 (EP) 10188134.0

(51) Int. Cl. B08B 9/00; B65D 51/00

(52) U.S. Cl. 134/22.1; 220/200

(57) ABSTRACT

The invention relates to a protective cap for sealing a connector for a container containing medical substances, a connector system and a method for cleaning and/or disinfecting a surface of a recessed membrane of a connector. The protective cap (1, 1′) according to the invention comprises an external cap section (2) and an internal cap section (3), wherein a substantially annular hollow space (4) is formed between the external cap section (2) and the internal cap section (3) for the insertion of an annular connection component (21) of a connector (20), wherein the internal cap section (2) contains a swab (5, 5′, 5″) for cleaning and/or disinfecting a membrane (23) of the connector (20) set back from the edge (22) of the connection component (21).

### Technical Field

The invention relates to a protective cap for sealing a connector for a container containing medical substances or nutrient solutions, a connector system, and a method for cleaning and/or disinfecting a surface of a recessed membrane of a connector having a protective cap.

### PRIOR ART

Document U.S. Pat. No. 7,763,006B2 discloses a protective cap, which may be placed on a syringe shaped port cleaner. On the inside of the protective cap there is an annular sponge on the base of the protective cap that may contain disinfectants.

Document WO2009123709 A2 discloses a cleaning device having a cap shaped housing and sponge disposed in said housing. The sponge is saturated in disinfectants. Furthermore, the cleaning device contains a cover that seals the housing together with the sponge, in order that the sponge be maintained in a sterile condition.

Documents WO2010/034470A1 and WO2005/037362A1 disclose connectors for containers containing medical substances, e.g. for infusion bags or transfusion bags.

### SHORT DESCRIPTION OF THE INVENTION

The protective cap according to the invention for sealing a connector for a container containing medical substances comprises an external cap section and an internal cap section, wherein a substantially annular hollow space is formed between the external cap section and the internal cap section for the insertion of a connection component of a connector, wherein the internal cap section contains a swab for cleaning and/or disinfecting a membrane of the connector set back from the edge of the connection component.

The term “annular” should comprise, in particular, substantially conical, cylindrical or hybrid shapes.

With the use of containers having connectors with recessed membranes, e.g. connectors such as those described in WO2010/034470A1 and WO2005/03762A1, there is the possibility that the surface of the membrane can be moistened by the contents of the container, e.g. a liquid medicine or nutrient solution, as a result of, for example, the extraction of a syringe, needle, or spike previously inserted in the connector. If the contents of the container are toxic, a moistened surface of the membrane poses a risk to the user, e.g. the hospital personnel. Furthermore, the moistening of the surface of the membrane may promote germ formation, limiting or preventing further removals of the contents from the container, after a certain period of time has passed.

By means of the protective cap according to the invention, it is possible to effectively clean and/or disinfect connectors with recessed membranes. Likewise, the protective cap enables a secure sealing of the opening of the connector. The protective cap can be simply placed on the connector, whereby it is ensured through the design of a swab in the internal cap section that the swabs safely reach the recessed membranes, and are able to clean and/or disinfect said.

Preferably the swab is designed such that the entire surface area, exposed as far as the external region, can be cleaned and/or disinfected. Preferably, the swab may be designed such that it can also clean and/or disinfect the inner surface of the connection component bordering the membrane. For this, the swab may exhibit, for example, a disk shaped end of suitable thickness facing the membrane.

Preferably the internal cap section contains an attachment projection to which the swab is attached. An attachment projection of this type ensures a secure and durable attachment of the swab.

Preferably, the internal part of the cap is designed with an outer surface that corresponds at least partially to the internal surface of the connection component of the connector, such that when the connector is placed in position, these two surfaces lie against one another on the entire circumference, at least in one portion of the surface. In this manner it is possible to generate a seal between the protective cap and the connector that can reduce the chance of an undesired leakage of the contents of the container.

It is particularly preferred that the outer surface of the attachment projection corresponds to the inner surface of the connection component, such that when the connector is placed in position, these two surfaces lie against one another on the entire circumference in at least one section. If the protective cap is constructed of a stiff material, as is preferred, it is possible to obtain an easily produced and released seal in this manner, using a connection component of an equally stiff material.

It is particularly preferred that the protective cap is designed as the male part of a Luer connector or a Luer Lock connector (ISO 594-1:1986/EN 20594-1:1993, or ISO 594-2:1998/EN1707:1996).

Preferably, the swab contains a cleaning agent, e.g. a sterilization agent or disinfectant. The swab may be designed, for example, as liquid absorbent, and be saturated with a cleaning agent of this type.

Further advantageous embodiments of the invention are the subject matter of the dependent claims.

The invention shall be explained below in greater detail based on embodiments illustrated by the numerous figures.

### SHORT DESCRIPTION OF THE ILLUSTRATIONS

They show:

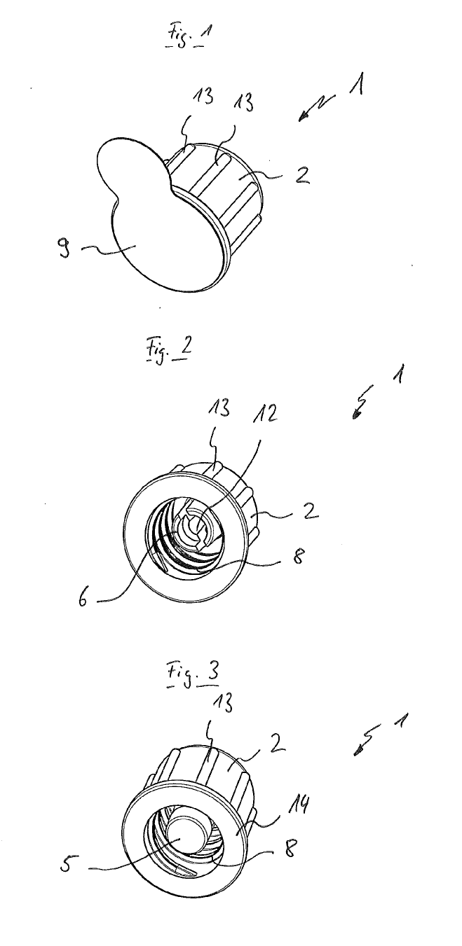

FIG. 1 A perspective view of a first embodiment of a protective cap according to the invention,

FIG. 2 A view of the protective cap shown in FIG. 1, in which the swab has been left out,

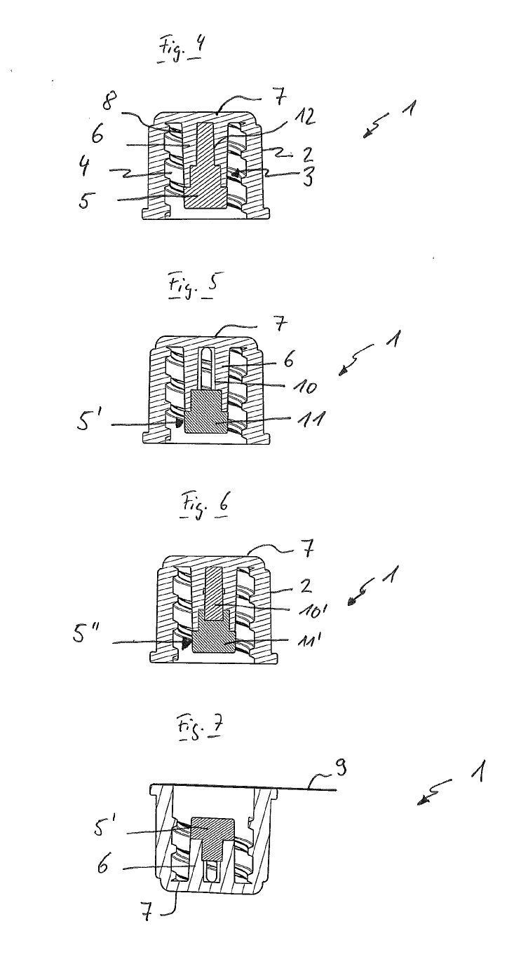

FIG. 3 A view of the protective cap shown in FIG. 1, with the swab,

FIG. 4 A cut-away illustration of the protective cap with a first swab,

FIG. 5 A cut-away illustration of the protective cap with a second swab,

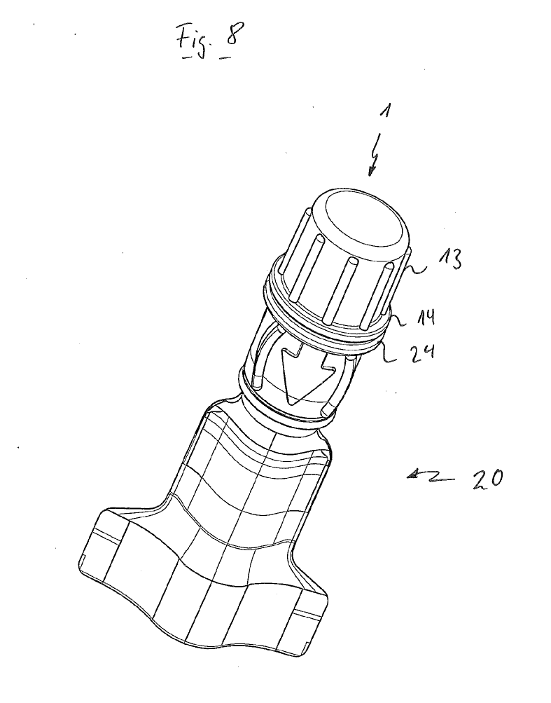

FIG. 6 A cut-away illustration of the protective cap with a third swab,

FIG. 7 A cut-away illustration of the protective cap with the second swab and a barrier film

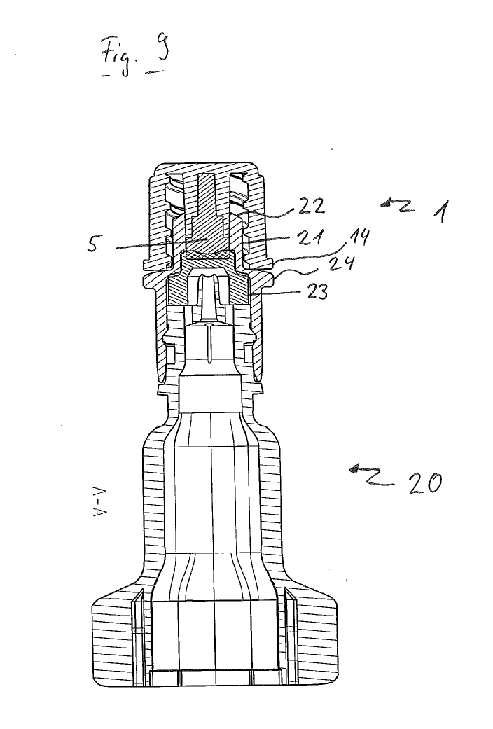

FIG. 8 A perspective view of a connector system with a protective cap according to a first embodiment, and a connector,

FIG. 9 A longitudinal cut through the connector system shown in FIG. 8,

FIG. 10 A perspective view of a second embodiment of a protective cap,

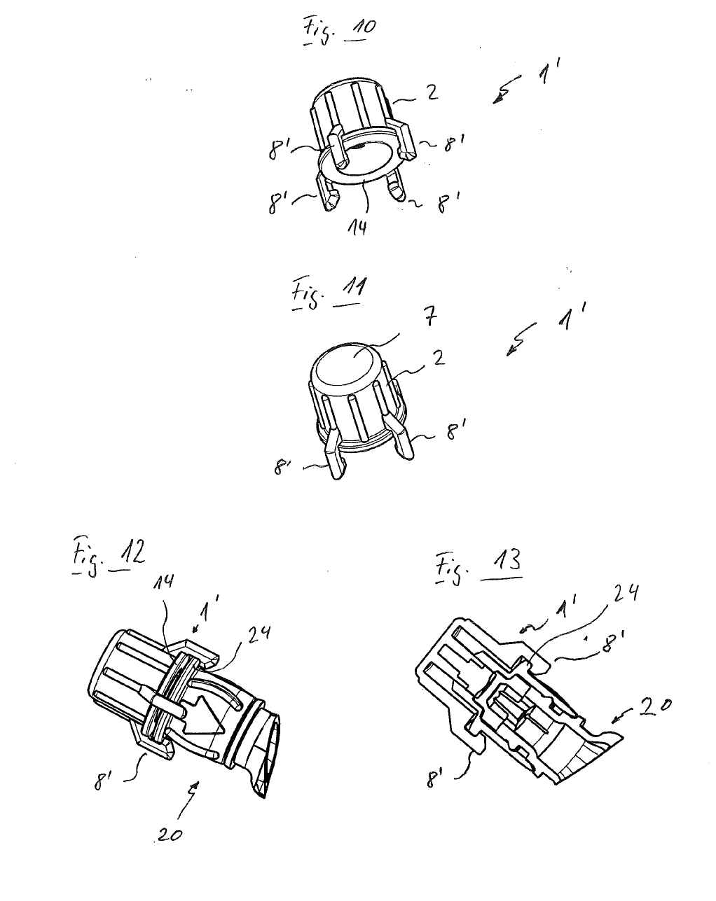

FIG. 11 A further perspective view of the protective cap shown in FIG. 10,

FIG. 12 A perspective view of a connector system with a protective cap according to a second embodiment, and a connector, and

FIG. 13 A longitudinal cut through the connector system shown in FIG. 12.

### DESCRIPTION OF THE EMBODIMENTS

FIGS. 1-7 show a first embodiment from different perspectives of a protective cap 1 according to the invention. FIGS. 8 and 9 show a connector system having a protective cap 1 and a connector 20 of this type.

The protective cap is for the secure sealing of a connector 20 for a container containing medical substances or nutrient solutions from, for example, bags or bottles, such as are used for infusion, transfusion, clinical nutrition or dialysis. The protective cap comprises an external cap section 2, an internal cap section 3 and a cap base 7. The external cap section 2 and the internal cap section 3 are connected to one another by means of the cape base 7. A substantially annular hollow space 4 for the insertion of an annular connection component 21 of the connector 20 is formed between the external cap section 2 and the internal cap section 3, i.e. between the inner surface of the external cap section 2 and the outer surface of the internal cap section 3. The outer surface of the external cap section 2 exhibits numerous ribs 13, which aid in the manipulation of the protective cap 1.

The internal cap section 3 contains an attachment projection 6 and a swab 5. The attachment projection 6 is located at the middle of the cap base 7. The outer diameter of the attachment projection 6 in this case has the dimensions of a Luer cone. The attachment projection 6 has a recess 12, in which the swab is placed. The recess 12 enables a secure attachment of the swab 5 to the attachment projection 6. In this embodiment, the recess 12 is shaped longitudinally in steps; see, for example, FIGS. 4-7.

The outer cap section 2, cap base 7 and attachment projection 6 are produced as a one-piece unit injection molded component of hard plastic, e.g. PP, PE, PA, PS or a mixture of PP and SEBS. As a result, the protective cap 1 can be produced economically. However, other materials or mixtures thereof, or a multi-part construction are also possible as a rule.

The swab 5 is designed for cleaning and/or disinfecting a membrane 23 of the connector 20 set back from the edge 22 of the connection component 21 (cf. FIG. 9). The swab 5 extends beyond the attachment projection 6 of the internal cap section 3. This ensures that the swab 5 can come in contact with as much surface area of the membrane 23 as possible, preferably with the entire exposed surface, and can clean and/or disinfect said. In this embodiment, the end of the swab 5 facing the membrane 23 is designed with a disk shape.

FIGS. 4-6 show different variants of the swab.

In a first variation (see FIG. 4) the swab 5 is designed as a one-piece unit. The swab 5 is preferably produced by filling the attachment projection 6 with an absorbent material, e.g. made of polyurethanes, ABS, nylon, polyester or polyolefins.

In a second variation (see FIG. 5) the swab 5′ is designed as a two-piece unit having an attachment part 10 and a swab part 11. The swab part 11 consists preferably of synthetics, foam, paper or cotton, which is attached at its rear in the hollow recess of the attachment part 10, to the attachment projection 6 by means of pressure, gluing or clamping.

In another variation (see FIG. 6) the swab 5″ is also designed as a two-piece unit having an attachment part 10 and a swab part 11. In this case the attachment part 10 is designed as a rod, which is attached to the attachment projection 6 by means of a locking fit.

The one-piece swabs 5, or the swab parts 11 respectively, are preferably made of a soft, particularly preferred is an elastic, material, in order that they be able to shape themselves to the surface of the membrane 23, and be able to come into contact with the entire surface of said.

The swab 5, 5′, 5″ is saturated in these embodiments with a disinfectant, e.g. isopropanol, ethanol, povidone-iodine or another disinfectant. As a rule other cleaning agents are also possible.

The external cap section 2 has an attachment means 8, which enables the protective cap 1 to be permanently attached to a connector 20. In this embodiment the attachment means 8 is designed as an internal threading which can act together with an (not shown) outer threading of the connector 20. In this manner, the protective cap 1 can be permanently, but in a manner that allows it to be removed, attached to the connector 20.

The protective cap 1 furthermore comprises a barrier film 9. The barrier film 9 seals in an airtight manner the internal region containing the swab 5, 5′, 5″ of the protective cap 1. In this manner, the barrier film 9 prevents contamination of the inner region and evaporation of the cleaning agent. The barrier film 9 is attached to the outer edge 14 of the external cap section 2 over its entire circumference in this embodiment, e.g. welded or glued to said. The barrier film 9 is designed with a projecting flap, which enables a simple manual releasing of the barrier film 9. The barrier film 9 can, for example, be an aluminum composite-layer foil, or a synthetic single-layer or composite-layer film.

The outer surface of the internal cap section 3 is conical in this version. In particular, the protective cap 1 is designed as a male component of a Luer Lock connector.

FIGS. 8 and 9 show an embodiment of a connector system according to the invention comprising a protective cap land a connector 20. Connectors 20 of this type are known from, for example, WO2010/034470 A1 and WO 2005/037362 A1. Regarding the structure of such connectors 20, reference is made to the aforementioned documents.

In this embodiment the connector 20 is designed as a female component of a Luer connector in the region of the connection component 21. By attaching the protective cap 1 to the connection component 21, aside from cleaning and/or disinfecting the surface of the recessed membrane 23 by means of the full-surface contacting of the membrane 23 by the swab 5, a seal is produced in that an encompassing section of the conical outer surface of the attachment projection 6 lies against in a continuous manner on the conical inner surface of the connection component 21. The protective cap 1 prevents, in this manner, not only contamination of the surface of the membrane, but also prevents leakage.

Because the swab 5 extends over the attachment projection 6 in the shape of a disk, a cleaning and/or disinfection of the section of the inner surface of the connection component 21 bordering on the membrane 23 is also obtained.

The internal cap section 3 of the protective cap 1 is designed with a length such that the surface of the membrane 23 is contacted, but the membrane 23 is not opened. As a result, the seal of the membrane 23 in the case of a self-sealing membrane 23, for example, is maintained. In order to stop the movement of the protective cap 1 at this end position, the connector 20 has a collar shaped edge 24 bordering on the connection component 21. The edge 24 forms a stop for the edge 14 of the external cap section 2. In this manner, an end position for the protective cap 1 is established.

FIGS. 10-13 illustrate a second embodiment of a protective cap 1′ according to the invention, having attachment means 8′, which enable a permanent, non-releasable attachment of the protective cap 1 to the connector 20. The attachment means 8′ in this case are designed as four spring-release hooks, molded onto the circumference of the outer surface of the external cap section 2. When the protective cap 1 is placed in position on the connector 20 and the end position has been reached, the hooks 8′ hook in a sprung manner onto the edge 24 of the connector 20. Removal of the protective cap 1 from the connector 20 is no longer possible. In this manner, repeated use of the connector 20 is prevented, and the membrane 23 is cleaned and/or disinfected and contamination of the contents of the container connected to the connector 20 is prevented.

The hooks 8′ may be constructed as a single-piece unit together with the external cap section 2, the internal cap section 3, and the cap base 7, or as multiple parts, in the form of injection molded parts made of plastic.

As an alternative variant, the protective cap 1′ with the snap-fit hooks may also be designed to be releasable. With this variant, the inner threading of the cap can be eliminated. The attachment of the cap to the connector is obtained by means of snap-fit hooks, which, in this case, are not designed for permanent attachment, but rather as a releasable attachment. For example, the protective cap can be designed such that the hooks will give when a sufficiently powerful tug is exerted on the protective cap, thus releasing from the edge 24 where they engage with the connector 20 (for example, if the hooks are designed to latch with a slanted or rounded hook, instead of a right-angle hook).

1. A protective cap for sealing a connector for containers containing medical substances, comprising an external cap section and an internal cap section, wherein a substantially annular hollow space is formed between the external cap section and the internal cap section for the insertion of an annular connection component of a connector, wherein the internal cap section contains a swab for cleaning and/or disinfecting a membrane of the connector set back from the edge of the connection component.

2. The protective cap according to claim 1, wherein the internal cap section has an attachment projection to which the swab is attached.

3. The protective cap according to claim 2, wherein the swab extends beyond the connection projection.

4. The protective cap according to claim 1, also comprising a cap base, wherein the external cap section and the internal cap section are connected to one another by means of the cap base.

5. The protective cap according to claim 1, wherein the internal cap section (3) displays a conical exterior.

6. The protective cap according to claim 1, wherein the swab is designed as a single-piece unit, and preferably comprises synthetics, foam, paper or cotton, or at least is constructed as a two-piece unit with an attachment part which is firmly attached to the attachment projection, and a swab part firmly attached to the connection part, wherein the swab part is preferably comprised of synthetics, foam, paper or cotton.

7. The protective cap according to claim 1, wherein the swab contains a disinfectant.

8. The protective cap according to claim 1, wherein the external cap section exhibits an attachment means for attaching the protective cap to the connector.

9. The protective cap according to claim 8, wherein the attachment means is designed to attach the protective cap to the connector in a releasable manner, in that, for example, the external cap section has an inner threading or the external cap section has one or more snap-fit type latching projections for hooking onto one or more hook projections on the connector in a releasable manner.

10. The protective cap according to claim 8, wherein the attachment means is designed to attach the protective cap to the connector in a non-releasable manner, in that, for example, the external cap section has one or more snap-fit type latching projections for permanently hooking onto one or more hook projections on the connector.

11. The protective cap according to claim 1, also comprising a barrier film, which seals the interior of the protective cap containing the swab in an airtight manner.

12. A connector system, comprising a protective cap according to claim 1, and a connector, wherein the connector has a connection component and a membrane set back from the edge of the connection component, wherein the connector and the protective cap are designed such that when the protective cap is placed in position on the connection component of the connector, the swab comes into contact with the protective cap of the membrane of the connector.

13. The connector system according to claim 12, wherein the connector and protective cap are designed such that when the protective cap is fully placed in location on the connection component of the connector, the swab comes into contact with the protective cap of the membrane of the connector, but does not open said.

14. The connector system according to claim 12, wherein the connector has blocking edge defining the end position of the protective cap on the connector.

15. A method for cleaning and/or disinfecting a surface of a recessed membrane of a connector with a protective cap according to claim 1, wherein the protective cap is place on a connection component of the connector and attached thereon, and upon obtaining an end position, in that the protective cap is attached to the connector, the swab comes into contact with the membrane and cleans and/or disinfects said.
